(19) United States
(12) Patent Application Publication
(10) Pub. No.: US 2003/0211848 A1
(43) Pub. Date: Nov. 13, 2003

(54) System and method for providing service negotiation during a hard handoff of a mobile station in a wireless communication system

(75) Inventors: Purva R. Rajkotia, Plano, TX (US); Yi Chun Chou, Golden, CO (US); William Joseph Semper, Richardson, TX (US); Joseph Robert Cleveland, Richardson, TX (US)

Correspondence Address: Docket Clerk, P.O. Box 800889, Dallas, TX, 75380, US

(73) Assignee: SAMSUNG ELECTRONICS CO., LTD., Suwon-city (KR)

(21) Appl. No.: 10/142,216

(22) Filed: May 9, 2002

(51) Int. Cl. H04Q 7/20

(52) U.S. Cl. 455/436; 455/439

(57) ABSTRACT

A system and method is disclosed for providing service negotiation during a hard handoff of a mobile station to a target base station in a wireless communication system. The target base station negotiates a Service Option with the mobile station using service negotiation messages. The mobile station receives the Service Option from the target base station and uses the Service Option to communicate with the target base station. The target base station and the mobile station each comprise a service negotiation controller that is capable of exchanging service negotiation messages to negotiate the Service Option for the mobile station.

### TECHNICAL FIELD OF THE INVENTION

The present invention is directed, in general, to wireless communication systems and devices and, more specifically, to a system and method for providing service negotiation during a hard handoff of a mobile station in a wireless communication system.

### BACKGROUND OF THE INVENTION

Wireless communication systems, including cellular phones, paging devices, personal communication services (PCS) systems, and wireless data networks, have become ubiquitous in society. Wireless service providers continually try to create new markets for wireless devices and to expand existing markets by making wireless devices and services cheaper and more reliable. The price of end-user wireless devices, such as cell phones, pagers, PCS systems, and wireless modems, has been driven down to the point where these devices are affordable to nearly everyone and the price of a wireless device is only a small part of the end-user's total cost. To continue to attract new customers, wireless service providers concentrate on reducing infrastructure costs and operating costs, and on increasing handset battery lifetime, while improving quality of service in order to make wireless services cheaper and better.

To maximize usage of the available bandwidth, a number of multiple access technologies have been implemented to allow more than one subscriber to communicate simultaneously with each base station (BS) in a wireless system. These multiple access technologies include time division multiple access (TDMA), frequency division multiple access (FDMA), and code division multiple access (CDMA). These technologies assign each system subscriber to a specific traffic channel that transmits and receives subscriber voice/data signals via a selected time slot, a selected frequency, a selected unique code, or a combination thereof.

CDMA technology is used in wireless computer networks, paging (or wireless messaging) systems, and cellular telephony. In a CDMA system, mobile stations and other access terminals (e.g., pagers, cell phones, laptop PCs with wireless modems) and base stations transmit and receive data on the same frequency in assigned channels that correspond to specific unique orthogonal codes. For example, a mobile station may receive forward channel data signals from a base station that are convolutionally coded, formatted, interleaved, spread with a Walsh code and a long pseudo-noise (PN) sequence. In another example, a base station may receive reverse channel data signals from the mobile station that are convolutionally encoded, block interleaved, modulated by a 64-ary orthogonal modulation, and spread prior to transmission by the mobile station. The data symbols following interleaving may be separated into an in-phase (I) data stream and a quadrature (Q) data stream for QPSK modulation of an RF carrier. One such implementation is found in the TIA/EIA-95 CDMA standard (also known as IS-95). Another implementation is the TIA/EIA-2000 standard (also known as IS-2000).

The current generation of cellular phones is used primarily for voice conversations between a subscriber device (or wireless device) and another party through the wireless network. A smaller number of wireless devices are data devices, such as personal digital assistants (PDAs) equipped with cellular/wireless modems. Because the bandwidth for a current generation wireless device is typically limited to a few tens of kilobits per second (kbps), the applications for the current generation of wireless devices are relatively limited. However, this is expected to change in the next (or third) generation of cellular/wireless technology, sometimes referred to as “3G” cellular/wireless, where much greater bandwidth will be available to each wireless device (i.e., one hundred twenty five thousand bits per second (125 kbps) or greater). The higher data rates will make Internet applications for wireless devices much more common. For instance, a 3G cellular telephone (or a PC with a 3G cellular modem) may be used to browse web sites on the Internet, to transmit and receive graphics, to execute streaming audio or video applications, and the like. A much higher percentage of the wireless traffic handled by 3G cellular systems will be Internet protocol (IP) traffic and a lesser percentage will be traditional voice traffic.

Real-time streaming of multimedia content over Internet protocol (IP) networks has become an increasingly common application in recent years. As noted above, 3G wireless networks will provide streaming data (both video and audio) to wireless devices for real time applications. A wide range of interactive and non-interactive multimedia Internet applications, such as news on-demand, live TV viewing, video conferencing, live radio broadcasting (such as Broadcast.com), and the like, will provide “real time” data streaming to wireless devices. Unlike a “downloaded” video file, which may be retrieved first in “non-real” time and viewed or played back later, real time (or streaming) data applications require a data source to encode and to transmit a streaming data signal over a network to a receiver, which must decode and play the signal (video or audio) in real time.

When a mobile station that is in communication with a base station in a first cell moves to a second cell that is served by another base station a handoff procedure transfers control of the call from the first cell to the second cell. A handoff may be either a “soft handoff” or a “hard handoff.” In a “soft handoff” a connection is made between the mobile station and the base station in the second cell before the existing connection is broken between the mobile station and the base station in the first cell. In a “hard handoff” the existing connection between the mobile station and the base station in the first cell is broken before a new connection is made between the mobile station and the base station in the second cell.

During a hard handoff of a mobile station in presently existing telecommunication systems the first base station (referred to as the “source base station”) sends a Handoff Required message to a mobile switching center. The Handoff Required message contains a Service Option parameter that identifies the Service Option that the source base station is using for the mobile station. The mobile switching center then sends a Handoff Request message to the second base station (referred to as the “target base station”). The Handoff Request message contains the Service Option parameter that identifies the Service Option that is currently being used by the source base station for the mobile station.

Upon receipt of the Handoff Request message from the mobile switching center, the target base station allocates appropriate radio resources as requested in the Handoff Request message and connects the call to the mobile station. The target base station then sends null forward traffic channel frames to the mobile station.

The target base station then sends a Handoff Request Ack message to the mobile switching center. The target base station will send the Handoff Request Ack message to the mobile switching center only if the target base station accepts the Service Option that was contained in the Handoff Request message. If the target base station does not accept the Service Option that was contained in the Handoff Request message, then the target base station will indicate that the handoff is rejected in the Handoff Request Ack message. The handoff of the mobile station to the target base station will not be possible.

Presently existing telecommunication systems are not capable of negotiating with a mobile station to change the Service Option that the mobile station is using. Presently existing handoff direction messages include the Universal Handoff Direction Message (UHDM), the General Handoff Direction Message (GHDM), and the Extended Handoff Direction Message (EHDM). None of these handoff direction messages are capable of negotiating a Service Option with a mobile station during a handoff of the mobile station.

The number of different types of mobile stations in the market that support different options and configurations is continually increasing. Therefore, there is a need for a telecommunication system that is capable of negotiating a Service Option with a mobile station during a hard handoff of the mobile station to a target base station. In particular, there is a need for a system and method that is capable of providing to a mobile station a Service Option that can be used by a target base station. There is a further need for a system and method that is capable of providing a mobile station that is capable of receiving and using a Service Option that can be used by a target base station.

### SUMMARY OF THE INVENTION

It is an object of the present invention to provide a system and method that is capable of providing service negotiation during a hard handoff of a mobile station to a target base station in a wireless network system.

The system and method of the invention comprises a target base station that is capable of providing a Service Option to a mobile station during a hard handoff of the mobile station to the target base station. The system and method of the invention also comprises a mobile station that is capable of receiving a Service Option from the target base station of the invention. The system and method of the invention also comprises service negotiation messages. The target base station and the mobile station are capable of exchanging the service negotiation messages to negotiate a Service Option for the mobile station to use to communicate with the target base station.

The base station controller of the target base station of the invention comprises a service negotiation controller. The service negotiation controller prepares service negotiation messages to be transmitted to the mobile station. The service negotiation controller also interprets incoming service negotiation messages received from the mobile station. The service negotiation controller coordinates the negotiation of a Service Option for the mobile station.

The mobile station of the invention also comprises a service negotiation controller. The service negotiation controller of the mobile station prepares service negotiation messages to be transmitted to the target base station. The service negotiation controller of the mobile station also interprets incoming service negotiation messages received from the target base station. The service negotiation controller of the mobile station coordinates the receipt of a Service Option from the target base station.

It is an object of the present invention to provide a target base station that is capable of providing a Service Option to a mobile station during a hard handoff of the mobile station.

It is also an object of the present invention to provide a target base station that is capable of sending service negotiation messages to a mobile station to negotiate a Service Option for the mobile station during a hard handoff of the mobile station to the target base station.

It is another object of the present invention to provide a mobile station that is capable of receiving a Service Option from a target base station during a hard handoff of the mobile station.

It is yet another an object of the present invention to provide a mobile station that is capable of sending service negotiation messages to a target base station to negotiate a Service Option for the mobile station during a hard handoff of the mobile station to the target base station.

It is an additional object of the present invention to provide service negotiation messages that are compliant with a CDMA 2000 Air Interface Standard that have been modified to include Service Option information.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior uses, as well as to future uses, of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 illustrates an exemplary prior art wireless network;

FIG. 2 illustrates an exemplary base station and an exemplary base transceiver station according to an advantageous embodiment of the present invention;

FIG. 3 illustrates an exemplary hard handoff of a wireless mobile station to a target base station according to an advantageous embodiment of the present invention;

FIG. 4 illustrates a chart of call flows showing that prior art telecommunications equipment is not capable of negotiating a service option during a hard handoff of mobile station from a source base station to a target base station;

FIG. 5 illustrates a chart of call flows showing how a target base station of the present invention negotiates a service option during a hard handoff of a mobile station using service negotiation messages of the present invention;

FIG. 6 illustrates a table that provides information concerning parameters of certain timers that are used in connection with the present invention;

FIG. 7 illustrates a table that sets forth the time required to make certain transitions from a first type of message to a second type of message;

FIG. 8 illustrates a chart of information elements that may be sent in a message from a target base station to a mobile switching center;

FIG. 9 illustrates an exemplary bitmap layout of a Handoff Complete message that contains service option information;

FIG. 10 illustrates a flow chart showing the steps of an advantageous embodiment of a method of the present invention for providing service negotiation during a hard handoff of a mobile station in a wireless communication system; and

FIG. 11 illustrates a chart showing mobile station service subfunctions of a mobile station and pathways that show the interaction of subfunctions of the mobile station.

### DETAILED DESCRIPTION OF THE INVENTION

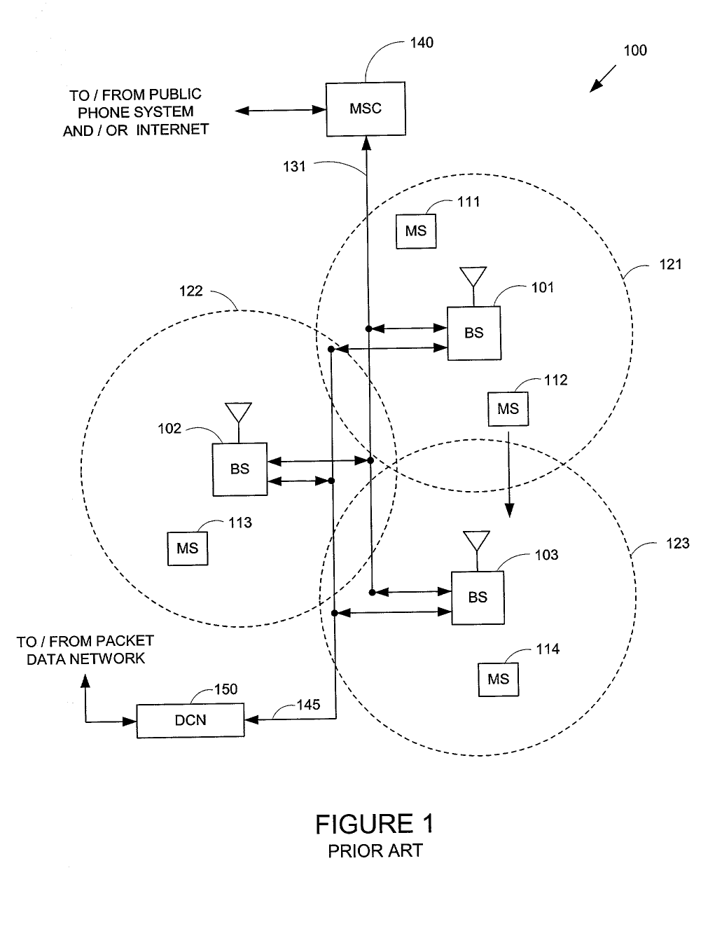

FIGS. 1 through 11, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged wireless mobile communications network.

FIG. 1 illustrates an exemplary prior art wireless network 100. Wireless network 100 comprises a plurality of cell sites 121-123, each containing one of the base stations, BS 101, BS 102, or BS 103. Base stations 101-103 are operable to communicate with a plurality of mobile stations (MS) 111-114. Mobile stations 111-114 may be any suitable wireless communication devices, including conventional cellular telephones, PCS handset devices, portable computers, telemetry devices, and the like, which are capable of communicating with the base stations via wireless links. Other types of access terminals, including fixed access terminals, also may be present in wireless network 100. However, for the sake of simplicity, only mobile stations are shown.

Dotted lines show the approximate boundaries of the cell sites 121-123 in which base stations 101-103 are located. The cell sites are shown approximately circular for the purposes of illustration and explanation only. It should be clearly understood that the cell sites may have other irregular shapes, depending on the cell configuration selected and natural and man-made obstructions.

Each of the base stations BS 101, BS 102, and BS 103 may comprise a base station controller (BSC) and a base transceiver station (BTS). Base station controllers and base transceiver stations are well known to those skilled in the art. A base station controller is a device that manages wireless communications resources, including the base transceiver station, for specified cells within a wireless communications network. A base transceiver station comprises the RF transceivers, antennas, and other electrical equipment located in each cell site. This equipment may include air conditioning units, heating units, electrical supplies, telephone line interfaces, and RF transmitters and RF receivers. For the purpose of simplicity and clarity in explaining the operation of the present invention, the base transceiver station in each of cells 121, 122, and 123 and the base station controller associated with each base transceiver station are collectively represented by BS 101, BS 102 and BS 103, respectively.

BS 101, BS 102 and BS 103 transfer voice and data signals between each other and the public telephone system (not shown) via communications line 131 and mobile switching center (MSC) 140. Mobile switching center 140 is well known to those skilled in the art. Mobile switching center 140 is a switching device that provides services and coordination between the subscribers in a wireless network and external networks, such as the public telephone system and/or the Internet. Communications line 131 links each vocoder in the base station controller (BSC) with switch elements in the mobile switching center (MSC) 140. In one advantageous embodiment, each link provides a digital path for transmission of voice signals in the pulse code modulated (PCM) format. Communications line 131 may be any suitable connection means, including a T1 line, a T3 line, a fiber optic link, a network backbone connection, and the like. In some embodiments, communications line 131 may be several different data links, where each data link couples one of BS 101, BS 102, or BS 103 to MSC 140.

BS 101, BS 102 and BS 103 transfer data signals between each other and the Internet or other packet data network (not shown) via communications line 145 and data core network (DCN) server 150. Data core network (DCN) server 150 is well known to those skilled in the art. Data core network (DCN) server 150 is a packet data switching or routing device that provides services and coordination between the subscribers in a wireless network and external packet data networks, such as a corporate Ethernet system and/or the Internet. Those skilled in the art will understand that line 145 interfaces to a packet data serving node (not shown) located in data core network (DCN) server 150. Communications line 145 may be any suitable connection line, including an Ethernet link, a T1 connection, a T3 line, a fiber optic link, a network backbone connection, and the like. In some embodiments, communications line 145 may comprise several different data links, where each data link couples one of BS 101, BS 102, or BS 103 to data core network (DCN) server 150.

In the exemplary wireless network 100, MS 111 is located in cell site 121 and is in communication with BS 101, MS 113 is located in cell site 122 and is in communication with BS 102, and MS 114 is located in cell site 123 and is in communication with ES 103. MS 112 is also located in cell site 121, close to the edge of cell site 123. The direction arrow proximate MS 112 indicates the movement of MS 112 towards cell site 123. At some point, as MS 112 moves into cell site 123 and out of cell site 121, a handoff will occur.

As is well known to those skilled in the art, the handoff procedure transfers control of a call from a first cell to a second cell. A handoff may be either a “soft handoff” or a “hard handoff.” In a “soft handoff” a connection is made between the mobile station and the base station in the second cell before the existing connection is broken between the mobile station and the base station in the first cell. In a “hard handoff” the existing connection between the mobile station and the base station in the first cell is broken before a new connection is made between the mobile station and the base station in the second cell.

For example, assume that mobile stations 111-114 communicate with base stations BS 101, BS 102 and BS 103 over code division multiple access (CDMA) channels. As MS 112 moves from cell 121 to cell 123, MS 112 determines that a handoff is required based on detection of a control signal from BS 103, increased bit error rate on signals from BS 101, signal time delay, or some other characteristic. When the strength of the control signal transmitted by BS 103, or the bit error rate of signals received from BS 101, or the round trip time delay exceeds a threshold, BS 101 initiates a handoff process by signaling MS 112 and the target BS 103 that a handoff is required. BS 103 and MS 112 proceed to negotiate establishment of a communications link. The call is thereby transferred from BS 101 to BS 103. An idle handoff is a handoff between cells of a mobile device that is communicating in the control or paging channel, rather than transmitting voice and/or data signals in the regular traffic channels.

One or more of the wireless devices in wireless network 100 may be capable of executing real time applications, such as streaming audio or streaming video applications. Wireless network 100 receives the real time data from, for example, the Internet through data core network (DCN) server 150 and through communications line 145 and transmits the real time data in the forward channel to the wireless device. For example, MS 112 may comprise a 3G cellular phone device that is capable of surfing the Internet and listening to streaming audio, such as music from the web site “www.mp3.com” or a sports radio broadcast from the web site “www.broadcast.com.” MS 112 may also view streaming video from a news web site, such as “www.CNN.com.” To avoid increasing the memory requirements and the size of wireless phone devices, one or more of the base stations in wireless network 100 provides real time data buffers that can be used to buffer real time data being sent to, for example, MS 112.

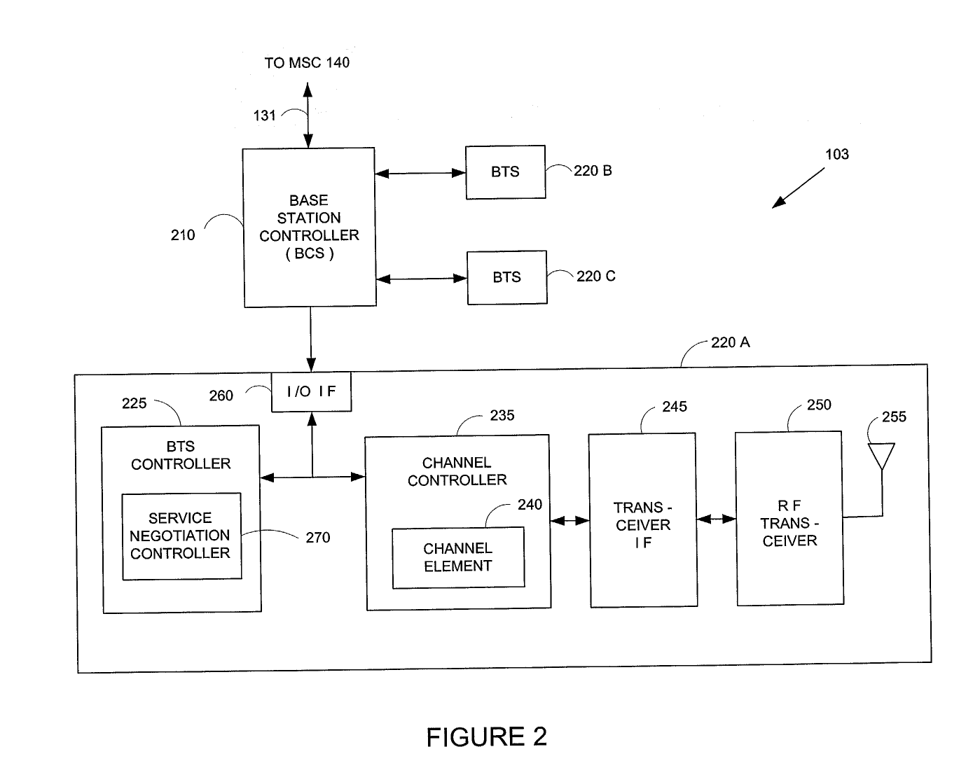

FIG. 2 illustrates exemplary base station 103 and base transceiver station (BTS) 220A according to an advantageous embodiment of the present invention. Base station 103 comprises base station controller (BSC) 210 and base transceiver stations BTS 220A, BTS 220B, and BTS 220C. Base station controllers and base transceiver stations were described previously in connection with FIG. 1.

BSC 210 manages the resources in cell site 123, including BTS 220A, BTS 220B, and BTS 220C. As described above, BSC 210 is coupled to MSC 140 over data communication line 131. Exemplary BTS 220A comprises BTS controller 225, channel controller 235 that contains exemplary channel element 240, transceiver interface (IF) 245, RF transceiver unit 250, and antenna array 255. Input/output interface (I/O IF) 260 couples BTS 220A to BSC 210.

BTS controller 225 controls the overall operation of BTS 220A and interfaces with BSC 210 through I/O IF 260. BTS controller 225 directs the operation of channel controller 235. Channel controller 235 contains a number of channel elements such as channel element 240. The channel elements perform bi-directional communications in the forward and reverse links. Depending on the air interface used by the system of BS 103, the channel elements engage in time division multiple access (TDMA), frequency division multiple access (FDMA), or code division multiple access (CDMA) communications with the mobile stations in cell 123.

Transceiver IF 245 transfers the bi-directional channel signals between channel controller 235 and RF transceiver 250. Transceiver IF 245 converts the radio frequency signal from RF transceiver 250 to an intermediate frequency (IF). Channel controller 235 then converts this intermediate frequency (IF) to baseband frequency. Additionally, RF transceiver 250 may contain an antenna selection unit to select among different antennas in antenna array 255 during both transmit and receive operations.

Antenna array 255 is comprised of a number of directional antennas that transmit forward link signals, received from RF transceiver 250, to mobile stations in the sectors covered by BS 103. Antenna array 255 also receives reverse link signals from the mobile stations and sends the signals to RF transceiver 250. In a preferred embodiment of the present invention, antenna array 255 is a multi-sector antenna, such as a six-sector antenna, in which each antenna is responsible for transmitting and receiving in a sixty degree (60°) arc of coverage area.

BS 103 of the present invention is not limited to the architecture described above. The architecture may be different depending on the type of air interface standard used by the wireless system. Additionally, the present invention is not limited by the frequencies used. Different air interface standards require different frequencies.

In an advantageous embodiment of the present invention, BTS controller 225 comprises a microprocessor (also known as a microcontroller) and a memory unit. The microprocessor and memory unit of BTS controller 225 are not shown in FIG. 2. BTS controller 225 is capable of executing software applications stored in the memory unit. BTS controller 225 also comprises a service negotiation controller 270. As will be more fully described, service negotiation controller 270 is capable of carrying out the present invention. Service negotiation controller 270 is an integral part of BTS controller 225.

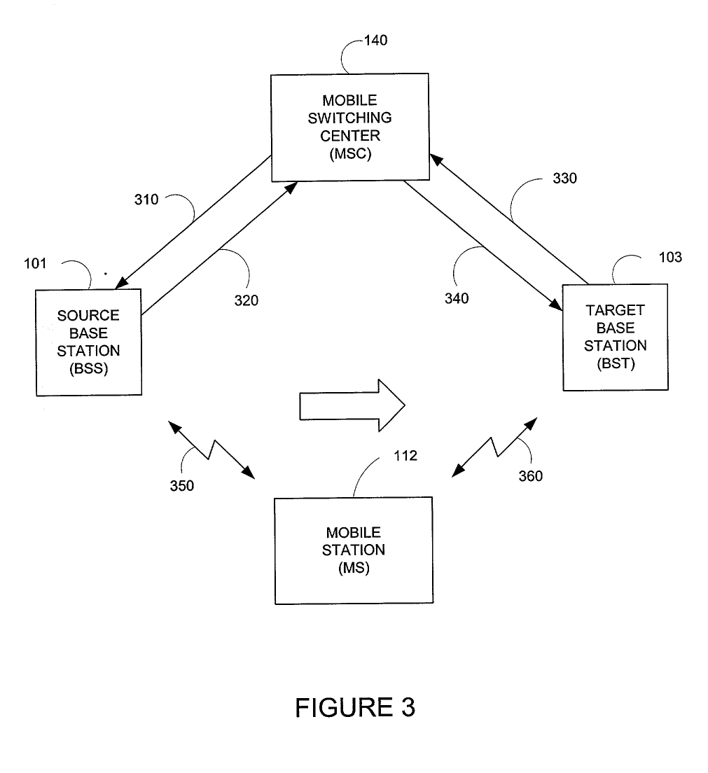

FIG. 3 illustrates an exemplary hard handoff of wireless mobile station 112 according to an advantageous embodiment of the present invention. Mobile station 112 is in motion away from base station 101 towards base station 103. Base station 101 is a source base station that is handing off mobile station 112. Base station 103 is a target base station to which source base station 101 hands off mobile station 112. Source base station 101 is in communication with mobile switching center 140 (indicated with arrows 310 and 320) and is in communication with mobile station 112 over an air interface 350. Target base station 103 is also in communication with mobile switching center 140 (indicated with arrows 330 and 340) and will also be in communication with mobile station 112 over an air interface 360. The exemplary configuration shown in FIG. 3 therefore comprises mobile station 112 (“MS”), source base station 101 (“BSS”), target base station 103 (“BST”) and mobile switching center 140 (“MSC”).

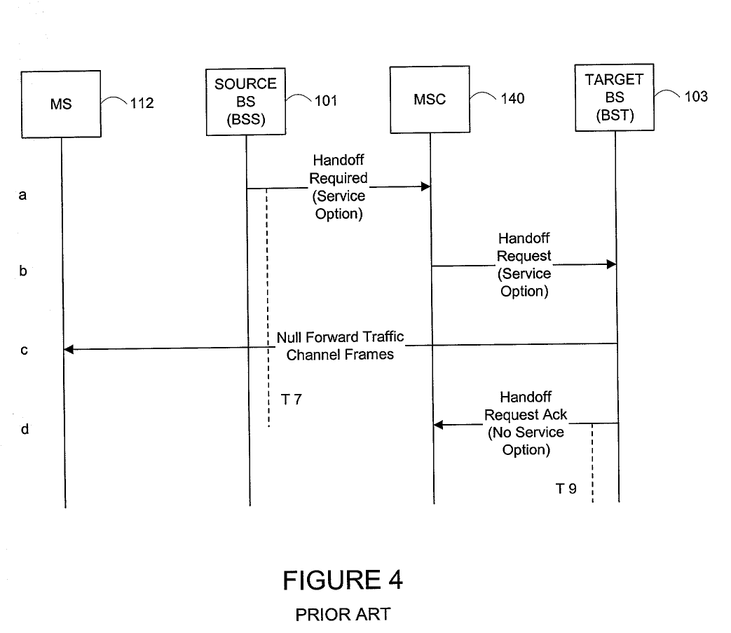

FIG. 4 illustrates a chart of call flows showing that prior art telecommunications equipment is not capable of negotiating a service option during a hard handoff of mobile station 112. Assume that mobile station 112 is communicating with source base station 101 on an active call. Source base station 101 determines that mobile station 112 needs to be handed off to target base station 103. Source base station 101 may make this determination by conventional means (e.g., by receiving a Pilot Strength Measurement Message from mobile station 112). Source base station 101 recommends a hard handoff (either intra-generation or inter-generation) to one or more cells in the domain of target base station 103.

As shown in FIG. 4, at time “a” source base station 101 sends a Handoff Required message to mobile switching center 140. The Handoff Required message contains a Service Option parameter that identifies the Service Option that source base station 101 is using for mobile station 112. Source base station 101 starts timer T7. The activation of timer T7 is shown as a dotted line in FIG. 4.

At time “b” mobile switching center 140 sends a Handoff Request message to target base station 103. The Handoff Request message contains the Service Option parameter that identifies the Service Option that is currently being used by source base station 101 for mobile station 112.

Upon receipt of the Handoff Request message from mobile ibex switching center 140, at time “c” target base station 103 allocates appropriate radio resources as requested in the Handoff Message and connects the call to mobile station 112. Target base station 103 sends null forward traffic channel frames to mobile station 112.

At time “d” target base station 103 sends a Handoff Request Ack message to mobile switching center 140. Target base station 103 starts timer T9 to wait for the arrival of a signal from mobile station 112 on the appropriate channel. The active period of timer T9 is shown as a dotted line in FIG. 4.

Target base station 103 will send the Handoff Request Ack message to mobile switching center 140 only if target base station 103 accepts the Service Option that was contained in the Handoff Request message. If target base station 103 does not accept the Service Option that was contained in the Handoff Request message, then target base station 103 will indicate that the handoff is rejected in the Handoff Request Ack message. The handoff will not be possible.

Service negotiation controller 270 of the present invention solves this problem by allowing the source base station 101 and target base station 103 to negotiate a Service Option during the hard handoff process.

As will be more fully described, the service negotiation messages of the present invention comprise a Service Request Message, a Service Response Message, a Service Connect Message, and a Service Connect Completion Message.

The service negotiation messages of the present invention are formatted in accordance with message standards set forth in the CDMA 2000 Air Interface Standard. In addition, the exchange of the service negotiation messages between source base station 101 and target base station 103 take place within standard timer values specified in the TIA/EIA-IS-2001A Interoperability Specifications for CDMA 2000 Access Network Interfaces. This means that the timer values for the service negotiation messages do not need to be extended. Standard timer values are used. The service negotiation messages therefore do not degrade the performance of the network.

The call flows of the service negotiation messages will be the same whether a call originates at mobile station 112 or terminates at mobile station 112. This is because the negotiation of the Service Option must originate at target base station 103. Target base station 103 receives the identity of the Service Option that mobile station 112 is currently using. If the Service Option that mobile station 112 is currently using is the same Service Option that target base station 103 is using, then there is no need to negotiate and use another Service Option. In such a case, target base station 103 simply uses the Service Option that is common to both mobile station 112 and target base station 103.

On the other hand, if the Service Option that mobile station 112 is currently using is different from the Service Option that target base station 103 uses, then target base station 103 uses the service negotiation messages to negotiate another Service Option that can be used by both mobile station 112 and target base station 103.

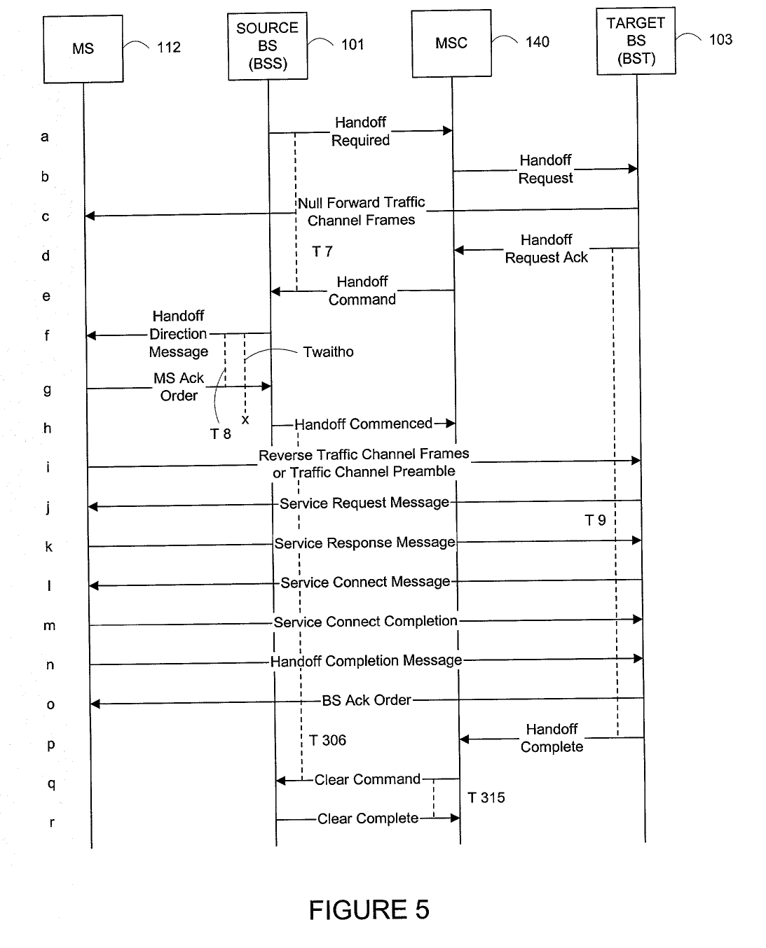

FIG. 5 illustrates a chart of call flows showing how target base station 103 negotiates a Service Option during a hard handoff of mobile station 112 using the service negotiation messages of the present invention. Assume that mobile station 112 is communicating with source base station 101 on an active call. Source base station 101 determines that mobile station 112 needs to be handed off to target base station 103. Source base station 101 may make this determination by conventional means (e.g., by receiving a Pilot Strength Measurement Message from mobile station 112). Source base station 101 recommends a hard handoff (either intra-generation or inter-generation) to one or more cells in the domain of target base station 103.

As shown in FIG. 5, at time “a” source base station 101 sends a Handoff Required message to mobile switching center 140. The Handoff Required message contains a Service Option parameter that identifies the Service Option that source base station 101 is using for mobile station 112. Source base station 101 starts timer T7. The active period of timer T7 is shown as a dotted line in FIG. 5.

At time “b” mobile switching center 140 sends a Handoff Request message to target base station 103. The Handoff Request message contains the Service Option parameter that identifies the Service Option that is currently being used by source base station 101 for mobile station 112.

Upon receipt of the Handoff Request message from mobile switching center 140, at time “c” target base station 103 allocates appropriate radio resources as requested in the Handoff Message and connects the call to mobile station 112. Target base station 103 sends null forward traffic channel frames to mobile station 112.

At time “d” target base station 103 sends a Handoff Request Ack message to mobile switching center 140. Target base station 103 starts timer T9 to wait for the arrival of a signal from mobile station 112 on the appropriate channel. The active period of timer T9 is shown as a dotted line in FIG. 5.

At time “e” mobile switching center 140 prepares to switch from source base station 101 to target base station 103. Mobile switching center 140 sends a Handoff Command to source base station 101. Source base station 101 then stops timer T7.

At time “f” source base station 101 sends a Handoff Direction message to mobile station 112 across the air interface. Source base station 101 then starts timer T8. The active period of timer T8 is shown as a dotted line in FIG. 5. If mobile station 112 is allowed to return to source base station 101, then source base station 101 also starts timer Twaitho. The active period of timer Twaitho is also shown as a dotted line in FIG. 5.

At time “g” mobile station 112 acknowledges the receipt of the Handoff Direction message by sending a Mobile Station (MS) Ack Order to source base station 101. Source base station 101 then stops timer T8. Note that if source base station 101 sends the Handoff Direction message to mobile station 112 using quick repeats, then source base station 101 might not request an acknowledgement from mobile station 112. In that case, source base station 101 would not have started timer T8 at time “f.”

At time “h” source base station 101 sends a Handoff Commenced message to mobile switching center 140 to notify mobile switching center 140 that mobile station 112 has been ordered to move to a channel of target base station 103. Source base station 101 starts timer 306 to wait for a Clear Command message from mobile switching center 140. The active period of timer T 306 is shown as a dotted line in FIG. 5. If timer Twaitho has been started, then source base station 101 waits for timer Twaitho to expire (shown with the letter “x” in FIG. 5) before sending the Handoff Commenced message to mobile switching center 140.

At time “i” mobile station 112 sends either reverse traffic channel frames or a traffic channel preamble to target base station 103.

At time “j” upon receipt of the reverse traffic channel frames or a traffic channel preamble from mobile station 112, target base station 103 determines whether the Service Option that is currently being used by mobile station 112 (i.e., the Service Option that is contained in the Handoff Request message sent by mobile switching center 140 at time “b”) is the same as the Service Option of target base station 103 (the “preferred” Service Option). If the Service Option being used by mobile station 112 and the preferred Service Option of target base station 103 are the same, then target base station 103 does not need to negotiate a Service Option. The next four (4) messages (i.e., the service negotiation messages) are then skipped.

If, however, the Service Option being used by mobile station 112 and the preferred Service Option of target base station 103 are different, then target base station 103 sends a Service Request message to mobile station 112 at time “j” to propose the use of the preferred Service Option of target base station 103.

If mobile station 112 cannot accept the preferred Service Option then mobile station 112 will send a “reject order.” The negotiation process will then start all over again. If mobile station can accept the preferred Service Option then mobile station 112 sends a Service Response message at time “k” to target base station 103 to accept the preferred Service Option proposed by target base station 103.

At time “l” target base station 103 sends a Service Connect message to mobile station 112 that specifies the service configuration for the call. Mobile station 112 then begins processing traffic in accordance with the specified Service Option.

At time “m” upon receipt of the Service Connect message from target base station 103, mobile station 112 responds and sends a Service Connect Completion message to target base station 103.

At time “n” mobile station 112 sends a Handoff Completion message to target base station 103.

At time “o” target base station 103 sends a Base Station (BS) Ack Order to mobile station 112 over the air interface.

At time “p” target base station 103 sends a Handoff Complete message to mobile switching center 140 to notify mobile switching center 140 that mobile station 112 has successfully completed a hard handoff and to notify mobile switching center 140 of the use of the new Service Option. Target base station 103 then stops timer T9.

At time “q” mobile switching center 140 sends a Clear Command message to source base station 101. Source base station 101 then stops timer 306. Mobile switching center 140 then starts timer T315. The active period of timer T 315 is shown as a dotted line in FIG. 5.

At time “r” source base station 101 sends a Clear Complete message to mobile switching center 140 to notify mobile switching center 140 that the clearing process has been completed. Mobile switching center 140 then stops timer T315.

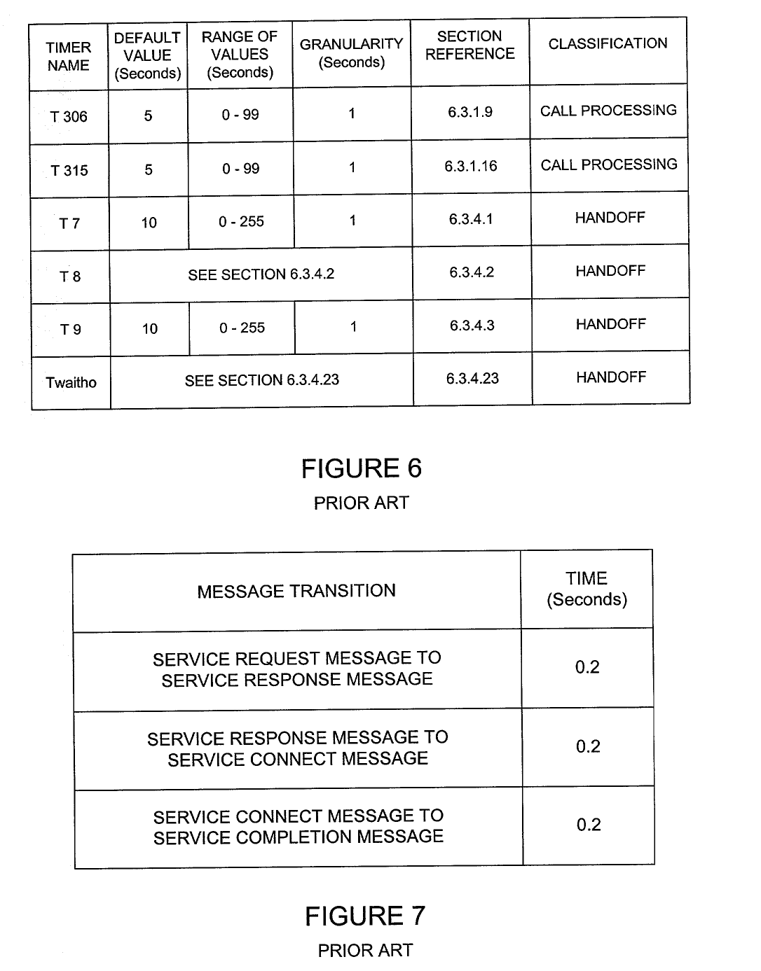

FIG. 6 illustrates certain entries of a table that is set forth in TIA/EIA-IS-2001A Interoperability Specifications for CDMA 2000 Access Network Interfaces (the “IOS” standard). The table entries provide information concerning the timers that are used in connection with the present invention. The references to numbered sections are refer to sections of the IOS standard.

FIG. 7 illustrates a table that sets forth the approximate Ad time required to make certain transitions from a first type of message to a second type of message. FIG. 7 shows that it requires approximately two tenths of a second (0.2 sec) to make a transition from a Service Request message to a Service Response message. Similarly, it also requires approximately two tenths of a second (0.2 sec) to make a transition from a Service Response message to a Service Connect message. Lastly, it requires approximately two tenths of a second (0.2 sec) to make a transition from a Service Connect message to a Service Completion message. These transition times are examples. A transition time may be longer or shorter than two tenths of a second (0.2 sec).

The timer default values shown in FIG. 6 and the message transition times shown in FIG. 7 show that the Service Option negotiation process of the present invention can be accomplished during the default value times of the timers that are specified in the IOS standard. This means that the default values of the times of the timers T7, T8, T9, T306 and T315 do not have to be increased in order to practice the present invention.

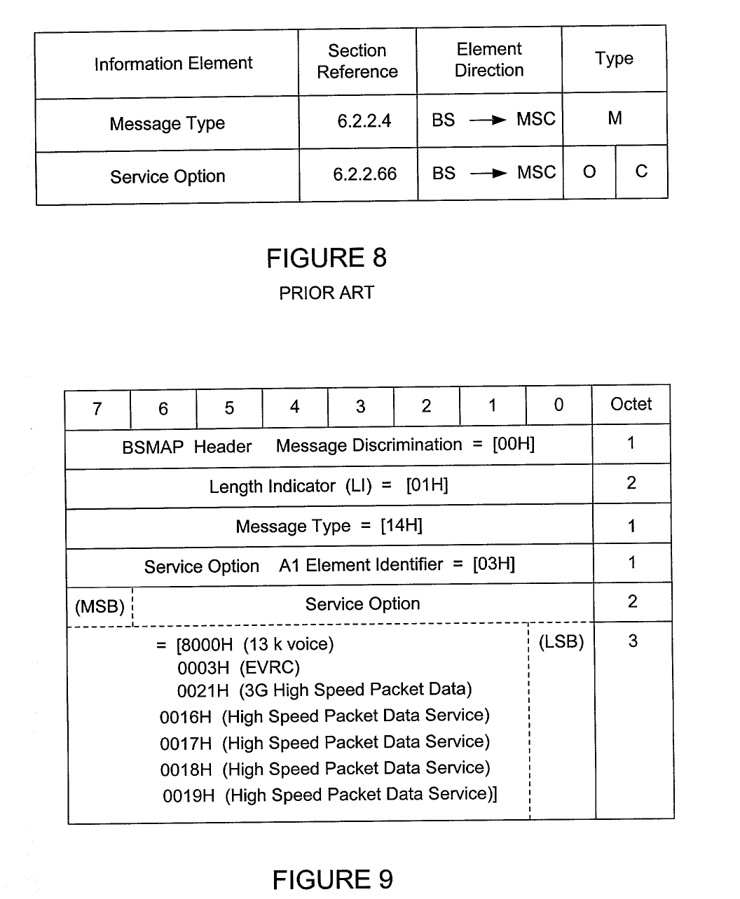

FIG. 8 illustrates a chart of information elements that may be sent using a BSMAP message. A BSMAP message is sent from target base station 103 to mobile switching center 140 to inform mobile switching center 140 that mobile station 112 has arrived on the new channel of target base station 103 and that mobile station 112 has completed all of the required connection procedures. The first line of the chart shows an information element called Message Type that identifies the type of message. The second line of the chart shows an information element called Service Option that identifies the type of Service Option. The Service Option information element is included during both intra-generation handoff and inter-generation handoff whenever service negotiation occurs on air interface 360 between target base station 103 and mobile station 112.

FIG. 9 illustrates an exemplary bitmap layout of a Handoff 20 Complete message that contains information concerning the Service Option negotiated by the present invention. Bits zero (0) through seven (7) of Octet 1 of the BSMAP Header field contain a hexadecimal number that indicates a value for the Message Discrimination. Bits zero (0) through seven (7) of Octet 2 of the BSMAP Header field contain a hexadecimal number that indicates a value for the Length Indicator of the message. Bits zero (0) through seven (7) of Octet 1 of the Message Type field contains a hexadecimal number that indicates a value for the Message Type of the message.

Bits zero (0) through seven (7) of Octet 1 of the Service Option field contain a hexadecimal number that indicates a value to for the A1 Element Identifier. Bits zero (0) through seven (7) of Octet 2 of the Service Option field and bits zero (0) through seven (7) of Octet 3 of the Service Option field contain a hexadecimal number that indicates a value for the Service Option of the message.

As shown in FIG. 9, the hexadecimal value 8000H represents a Service Option for 13 k Voice. The hexadecimal value 0003H represents a Service Option for EVRC. The hexadecimal value 0021H represents a Service Option for 3G (“third generation”) high speed packet data. The hexadecimal values 0016H, 0017H, 0018H and 0019H represent Service Options for high speed packet data service.

The service negotiation messages described above are handled in BTS controller 225 of target base station 103 in service negotiation controller 270. Service negotiation controller 270 prepares the service negotiation messages to be transmitted by target base station 103. Service negotiation controller 270 also interprets incoming service negotiation messages from mobile station 112. The mobile station 112 also comprises a similar service negotiation controller (not shown) for interpreting incoming service negotiation messages from target base station 103 and for sending service negotiation messages to target base station 103.

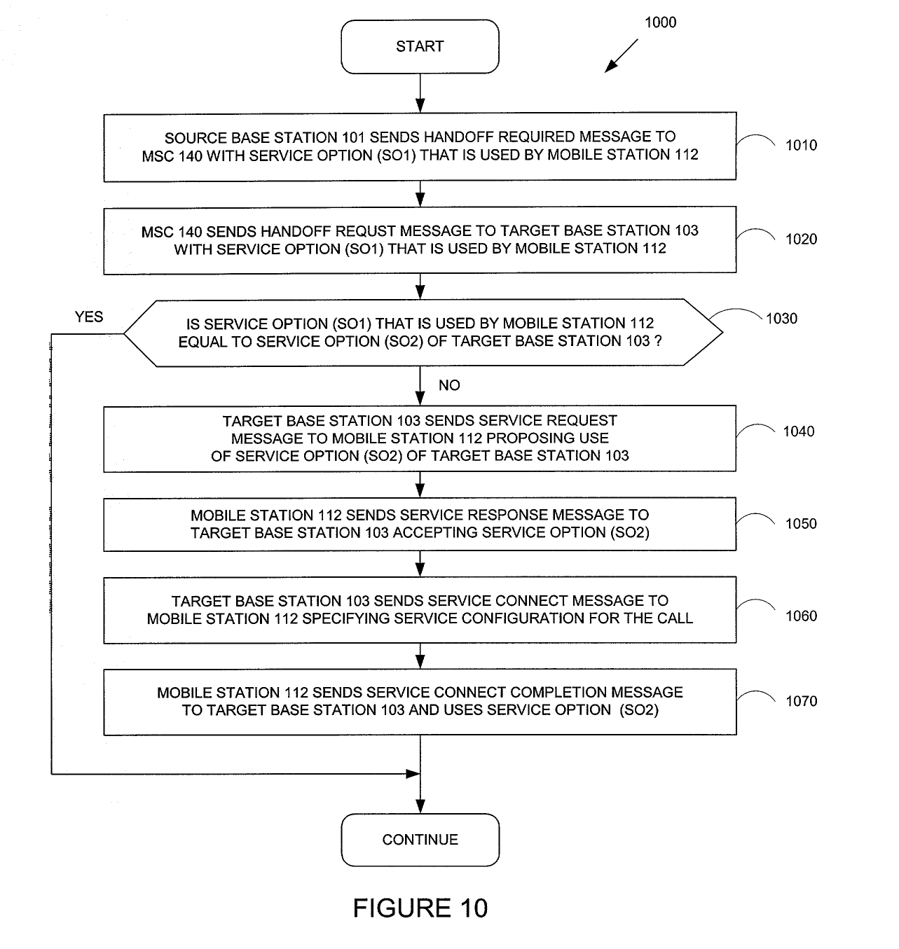

FIG. 10 illustrates a flow chart showing the steps of an advantageous embodiment of a method of the present invention for providing service negotiation during a hard handoff of a mobile station in a wireless communication system. The steps of the method are collectively referred to with reference numeral 1000.

At the beginning of the method mobile station 112 is in communication with source base station 101. Source base station 101 sends a Handoff Required message to mobile switching center 140 that contains a Service Option parameter that identifies the Service Option (designated “SO1”) that is currently being used by mobile station 112 (step 1010). Mobile switching center 140 sends a Handoff Request message to target base station 103 that contains a Service Option parameter that identifies the Service Option (“SO1”) that is currently being used by mobile station 112 (step 1020).

Target base station 103 then determines whether the Service Option (“SO1”) that is currently being used by mobile station 112 is the same as the preferred Service Option (designated “SO2”) that is being used by target base station 103 (decision step 1030). If the Service Option (“SO1”) that is currently being used by mobile station 112 is the same as the preferred Service Option (“SO2”) that is being using by target base station 103, then it is not necessary to negotiate another Service Option and the process continues without sending the service negotiation messages of the present invention.

If the Service Option (“SO1”) that is currently being used by mobile station 112 is not the same as the preferred Service Option (“SO2”) that is being using by target base station 103, then target base station 103 sends a Service Request message to mobile station 112 proposing to use the preferred Service Option (“SO2”) that is being using by target base station 103 (step 1040).

Mobile station 112 then determines whether it is able to accept the preferred Service Option (“SO2”) (decision step 1050). If mobile station 112 cannot accept the preferred Service Option then mobile station 112 will send a “reject order” and the negotiation process will end. The negotiation process will then have to be started over again. If mobile station can accept the preferred Service Option (“SO2”) then mobile station 112 responds by sending a Service Response message to target base station 103 accepting the preferred Service Option (“SO2”) (step 1060).

Target base station 103 then sends a Service Connect message to mobile station 112 specifying the service configuration for the call (step 1070). Mobile station 112 uses the preferred Service Option (“SO2”) and sends a Service Connect Completion message to target base stations 103 (step 1080). The processing of the call then continues as previously described in connection with FIG. 5.

FIG. 11 illustrates a chart 1100 showing mobile station service subfunctions of mobile station 112 and pathways that show the interaction of subfunctions of mobile station 112. In particular, chart 1100 shows the location and operation of Service Negotiation Subfunction 940 of the present invention with respect to other subfunctions of mobile station 112.

Normal Service Subfunction 920 represents normal service of mobile station 112. Service Option Negotiation Subfunction 920 negotiates a Service Option in situations other than a hard handoff of mobile station 112. The numbered circles in FIG. 11 refer to interactions of the subfunction blocks shown in FIG. 11.

Normal Service Subfunction 920 receives a Service Request Message proposing and sends a Service Request Message rejecting (Circle 1).

Normal Service Subfunction 920 also receives requests for service negotiation (Circle 2).

Normal Service Subfunction 920 also receives input from Service Option Negotiation Subfunction 910 when a SERV_NEG signal is enabled (Circle 3).

Waiting for Service Connect Message Subfunction 970 receives Service Request Message proposing and sends Service Response Message accepting (Circle 4).

Waiting for Service Request Message Subfunction 930 receives Service Request Message proposing and sends Service Response Message proposing (Circle 5).

Waiting for Service Response Message Subfunction 950 receives user requests for new service configuration and sends Service Request Message proposing (Circle 6).

Waiting for Service Request Message Subfunction 930 receives Service Request Message proposing and sends Service Response Message proposing (Circle 7).

Waiting for Service Request Message Subfunction 930 receives Service Request Message rejecting or receives Service Request Message proposing and sends Service Response Message rejecting (Circle 8).

After action time passes Service Negotiation Subfunction 940 uses new service configuration and sends to Normal Service Subfunction 920 a Service Connect Completion Message (Circle 9).

Waiting for Service Response Message Subfunction 950 receives Service Response Message rejecting or Service Response Message proposing and sends Service Request Message rejecting (Circle 10).

Waiting for Service Response Message Subfunction 950 receives it Service Response Message proposing and sends Service Request Message proposing (Circle 11).

Normal Service Subfunction 920 sends a Service Connect Message (“SCM”), a General Handoff Direction Message (“GHDM”), or a Universal Handoff Direction Message (“UHDM”) to the Waiting for Service Action Time Subfunction 960 (Circle 12).

Waiting for Service Action Time Subfunction 960 receives a Service Connect Message (“SCM”), a General Handoff Direction Message (“GHDM”), or a Universal Handoff Direction Message (“UHDM”) from Waiting for Service Request Message Subfunction 930 (Circle 13).

Waiting for Service Action Time Subfunction 960 receives a Service Connect Message (“SCM”), a General Handoff Direction Message (“GHDM”), or a Universal Handoff Direction Message (“UHDM”) from Waiting for Service Response Message Subfunction 950 (Circle 14).

Waiting for Service Connect Message Subfunction 970 receives Service Request Message proposing and sends Service Response Message accepting (Circle 15).

Waiting for Service Action Time Subfunction 960 receives a Service Connect Message (“SCM”), a General Handoff Direction Message (“GHDM”), or a Universal Handoff Direction Message (“UHDM”) from Waiting for Service Connect Message Subfunction 970 (Circle 16).

Waiting for Service Connect Message Subfunction 970 receives Service Response Message proposing and sends Service Request Message accepting (Circle 17).

Although the present invention has been described in detail, those skilled in the art should understand that they can make various changes, substitutions and alterations herein without departing from the spirit and scope of the invention in its broadest form.

What is claimed is:

1. For use in a wireless communication system comprising at least two base stations and a mobile station, an apparatus for providing service negotiation with a mobile station during a hard handoff of said mobile station in said wireless communication system, said apparatus comprising:
a target base station that is capable of providing a service option to a mobile station; and
a mobile station that is capable of receiving said service option from said target base station.

2. The apparatus as claimed in claim 1 wherein said target base station is capable of determining whether a service option of said mobile station and a service option of said target base station are identical service options.

3. The apparatus as claimed in claim 2 wherein said target base station is capable of negotiating a service option with said mobile station when said target base station determines that a service option of said mobile station and a service option of said target base station are not identical service options.

4. The apparatus as claimed in claim 1 wherein said target base station is capable of sending at least one first service negotiation message to said mobile station to negotiate a service option for said mobile station.

5. The apparatus as claimed in claim 4 wherein said at least one first service negotiation message comprises a service request message that comprises service option information.

6. The apparatus as claimed in claim 4 wherein, in response a to receiving said at least one first service negotiation message from said target base station, said mobile station is capable of sending at least one second service negotiation message to said target base station to accept a service option from said target base station.

7. The apparatus as claimed in claim 6 wherein said at least one second service negotiation message comprises a service response message that comprises service option information.

8. The apparatus as claimed in claim 7 wherein said target base station is capable of sending at least one service connect message to said mobile station.

9. The apparatus as claimed in claim 8 wherein said mobile station is capable of sending at least one service connect completion message to said target base station.

10. The apparatus as claimed in claim 1 wherein said target base station comprises a service negotiation controller that is capable of sending at least one service negotiation message to said mobile station to provide a service option to said mobile station; and
wherein said mobile station comprises a service negotiation controller that is capable of receiving at least one service negotiation message from said target base station to receive said service option from said target base station.

11. The apparatus as claimed in claim 1 wherein said target base station is capable of sending to said mobile station one of: a service request message and a service connect message.

12. The apparatus as claimed in claim 11 wherein said mobile station is capable of sending to said target base station one of: a service response message and a service connect completion message.

13. For use in a wireless communication system comprising at least two base stations and a mobile station, a method for providing service negotiation with a mobile station during a hard handoff of said mobile station in said wireless communication system, said method comprising the steps of:
providing a service option to a mobile station from a target base station; and
receiving said service option in said mobile station from said target base station.

14. The method as claimed in claim 13 further comprising the step of:
determining in said target base station whether a service option of said mobile station and a service option of said target base station are identical service options.

15. The method as claimed in claim 14 further comprising the step of:
negotiating a service option with said mobile station when said target base station determines that a service option of said mobile station and a service option of said target base station are not identical service options.

16. The method as claimed in claim 13 further comprising the step of:
sending at least one first service negotiation message from said target base station to said mobile station to negotiate a service option for said mobile station.

17. The method as claimed in claim 16 wherein said at least one first service negotiation message comprises a service request message that comprises service option information.

18. The method as claimed in claim 16 further comprising the step of:
in response to receiving in said mobile station said at least one first service negotiation message from said target base station, sending at least one second service negotiation message from said mobile station to said target base station to accept a service option from said target base station.

19. The method as claimed in claim 18 wherein said at least one second service negotiation message comprises a service response message that comprises service option information.

20. The method as claimed in claim 19 further comprising the step of:
sending at least one service connect message from said target base station to said mobile station.

21. The method as claimed in claim 20 further comprising the step of:
sending at least one service connect completion message from said mobile station to said target base station.

22. The method as claimed in claim 13 further comprising the steps of:
sending at least one service negotiation message from a service negotiation controller of said target base station to said mobile station to provide a service option to said mobile station; and
receiving at least one service negotiation message from said target base station in a service negotiation controller of said mobile station to receive said service option from said target base station.

23. The method as claimed in claim 13 further comprising the step of:
sending from said target base station to said mobile station one of: a service request message and a service connect message.

24. The method as claimed in claim 23 further comprising the steps of:
sending from said mobile station to said target base station one of: a service response message and a service connect completion message.
